(19) United States
(12) Patent Application Publication
(10) Pub. No.: US 2024/0202643 A1
(43) Pub. Date: Jun. 20, 2024

(54) INFORMATION PROCESSING APPARATUS, BUSINESS ACTION EXTRACTION METHOD, AND STORAGE MEDIUM

(71) Applicant: NEC Corporation, Tokyo (JP)

(72) Inventor: Naoki YOSHINAGA, Tokyo (JP)

(73) Assignee: NEC Corporation, Tokyo (JP)

(21) Appl. No.: 18/533,386

(22) Filed: Dec. 8, 2023

(30) Foreign Application Priority Data
Dec. 15, 2022 (JP) 2022-200603

(51) Int. Cl. G06Q 10/067; G06Q 10/10

(52) U.S. Cl. CPC G06Q 10/067; G06Q 10/10

(57) ABSTRACT

In order to accurately extract a business action from a document such as a daily business report, an information processing apparatus includes: an analysis section that analyzes a dependency structure of a sentence contained in a document concerning a business activity; a target extraction section that extracts, from the sentence, at least one word indicative of a target of a business action; and a business action extraction section that, on the basis of a result of analysis by the analysis section, extracts, as a word indicative of the business action, at least one word having a dependency relation with the at least one word extracted by the target extraction section.

This Nonprovisional application claims priority under 35 U.S.C. § 119 on Patent Application No. 2022-200603 filed in Japan on Dec. 15, 2022, the entire contents of which are hereby incorporated by reference.

### TECHNICAL FIELD

The present invention relates to a technique for supporting a business activity.

### BACKGROUND ART

A technique for supporting a business activity is required. For example, Patent Literature 1 discloses, as an apparatus that generates information useful for a business activity, an apparatus that subjects text data contained in a daily report to a natural language analysis process so as to extract a phrase contained in the daily report, uses the extracted phrase to carry out a predetermined analysis process, and generates information useful for a business activity.

### CITATION LIST

### Patent Literature

### [Patent Literature 1]

Japanese Patent Application Publication Tokukai No. 2017-191442

### SUMMARY OF INVENTION

### Technical Problem

Note that a report such as a daily report contains not only a phrase (at least one word) indicative of details of a business action but also a phrase less related to the business action. The technique disclosed in Patent Literature 1 causes the following problem. Specifically, in this technique, since a phrase is extracted by carrying out a natural language analysis process with respect to text data contained in a daily report, a phrase less related to a business action is also extracted. This prevents proper generation of information useful for a business activity.

An example aspect of the present invention has been made in view of the above problems, and an example object thereof is to provide a technique that makes it possible to accurately extract a business action from a document such as a daily business report.

### Solution to Problem

An information processing apparatus according to an example aspect of the present invention includes at least one processor, the at least one processor carrying out: an analysis process for analyzing a dependency structure of a sentence contained in a document concerning a business activity; a target extraction process for extracting, from the sentence, at least one word indicative of a target of a business action; and a business action extraction process for, on the basis of a result of analysis in the analysis process, extracting, as a word indicative of the business action, at least one word having a dependency relation with the at least one word extracted in the target extraction process.

A business action extraction method according to an example aspect of the present invention includes: (a) analyzing a dependency structure of a sentence contained in a document concerning a business activity; (b) extracting, from the sentence, at least one word indicative of a target of a business action; and (c) on the basis of a result of analysis in (a), extracting, as a word indicative of the business action, at least one word having a dependency relation with the at least one word extracted in (b), (a) to (c) each being carried out by at least one processor.

A storage medium according to an example aspect of the present invention is a non-transitory computer-readable storage medium storing therein a program for causing a computer to function as a business action extraction apparatus, the program causing the computer to carry out: (i) a process for analyzing a dependency structure of a sentence contained in a document concerning a business activity; (ii) a process for extracting, from the sentence, at least one word indicative of a target of a business action; and (iii) a process for, on the basis of a result of analysis in the process (i), extracting, as a word indicative of the business action, at least one word having a dependency relation with the at least one word extracted in the process (ii).

A business action extraction system according to an example aspect of the present invention includes: an analysis means that analyzes a dependency structure of a sentence contained in a document concerning a business activity; a target extraction means that extracts, from the sentence, at least one word indicative of a target of a business action; and a business action extraction means that, on the basis of a result of analysis by the analysis means, extracts, as a word indicative of the business action, at least one word having a dependency relation with the at least one word extracted by the target extraction means.

### Advantageous Effects of Invention

An example aspect of the present invention makes it possible to accurately extract a business action from a document such as a daily business report.

### BRIEF DESCRIPTION OF DRAWINGS

FIG. 1 is a block diagram illustrating a configuration of an information processing apparatus according to a first example embodiment.

FIG. 2 is a flowchart showing a flow of an information processing method according to the first example embodiment.

FIG. 3 is a block diagram illustrating a configuration of a business action extraction system according to the first example embodiment.

FIG. 4 is a block diagram illustrating a configuration of an information processing apparatus according to a second example embodiment.

FIG. 5 is a diagram illustrating an example of a word indicative of a target and extracted by a business target extraction section according to the second example embodiment.

FIG. 6 is a diagram illustrating an example of the word indicative of the target and extracted by the business target extraction section according to the second example embodiment.

FIG. 7 is a flowchart showing an example flow of a recommendation information output process according to the second example embodiment.

FIG. 8 is a flowchart showing an example flow of a training phase execution process according to the second example embodiment.

FIG. 9 is a block diagram illustrating a configuration of a computer functioning g as each of information processing apparatuses according to the respective example embodiments of the present invention.

### EXAMPLE EMBODIMENTS

### First Example Embodiment

The following description will discuss a first example embodiment of the present invention in detail with reference to the drawings. The present example embodiment is an embodiment serving as a basis for an example embodiment described later.

### (Configuration of Information Processing Apparatus)

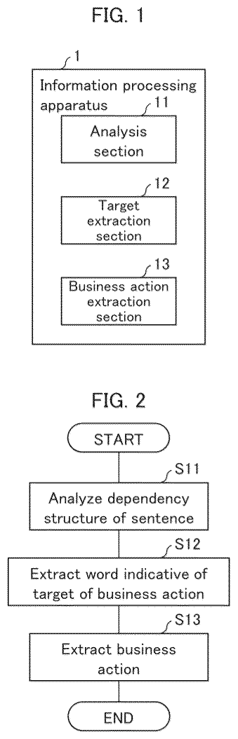

The following description will discuss a configuration of an information processing apparatus 1 according to the present example embodiment with reference to FIG. 1. FIG. 1 is a block diagram illustrating the configuration of the information processing apparatus 1. The information processing apparatus 1 includes i an analysis section 11 (analysis means), a target extraction section 12 (target extraction means), and a business action extraction section 13 (business action extraction means).

The analysis section 11 analyzes a dependency structure of a sentence contained in a document concerning a business activity. The analysis section 11 may acquire data indicative of a document that is input via an input/output section of the information processing apparatus 1. Alternatively, the analysis section 11 may acquire the data from a storage location (which may be in a storage apparatus of the information processing apparatus 1 or in a storage apparatus outside the information processing apparatus 1) specified by a user of the information processing apparatus 1. The analysis section 11 may acquire the data by receiving the data from another apparatus via a communication section of the information processing apparatus 1.

The target extraction section 12 extracts, from the sentence, at least one word indicative of a target of a business action. On the basis of a result of analysis by the analysis section 11, the business action extraction section 13 extracts, as a word indicative of the business action, at least one word having a dependency relation with the word extracted by the target extraction section 12.

The business action extraction section 13 may output, to an output apparatus (display apparatus, etc.) connected to the input/output section of the information processing apparatus 1, data indicative of the extracted word. Alternatively, the business action extraction section 13 may transmit the data to another apparatus connected via the communication section. The business action extraction section 13 may output the data by writing the data to the storage location (which may be in the storage apparatus of the information processing apparatus 1 or in the storage apparatus outside the information processing apparatus 1) specified by the user of the information processing apparatus 1. The word extracted by the business action extraction section 13 may be used to generate information for recommending the business action.

As described above, a configuration is employed such that the information processing apparatus 1 according to the present example embodiment includes: the analysis section 11 that analyzes a dependency structure of a sentence contained in a document concerning a business activity; the target extraction section 12 that extracts, from the sentence, at least one word indicative of a target of a business action; and the business action extraction section 13 that, on the basis of a result of analysis by the analysis section 11, extracts, as a word indicative of the business action, at least one word having a dependency relation with the at least one word extracted by the target extraction section 12. According to the information processing apparatus 1 according to the present example embodiment, a word having no dependency relation with a word indicative of a target of a business action is not extracted as the business action. This brings about an effect of making it possible to accurately extract a business action from a document such as a daily business report.

### (Program)

The foregoing functions of the information processing apparatus 1 can also be realized by a program. A program according to the present example embodiment is a program for causing a computer to carry out: (i) a process for analyzing a dependency structure of a sentence contained in a document concerning a business activity; (ii) a process for extracting, from the sentence, at least one word indicative of a target of a business action; and (iii) a process for, on the basis of a result of analysis in the process (i), extracting, as a word indicative of the business action, at least one word having a dependency relation with the at least one word extracted in the process (ii).

### (Flow of Information Processing Method)

The following description will discuss a flow of an information processing method S1 according to the present example embodiment with reference to FIG. 2. FIG. 2 is a flowchart showing the flow of the information processing method S1. Note that steps of the information processing method S1 may be carried out by a processor of the information processing apparatus 1 or by a processor of another apparatus.

In S11, at least one processor analyzes a dependency structure of a sentence contained in a document concerning a business activity. In S12, the at least one processor extracts, from the sentence, at least one word indicative of a target of a business action. In S13, on the basis of a result of analysis in step S11, the at least one processor extracts, as a word indicative of the business action, at least one word having a dependency relation with the word extracted in step S12.

As described above, a configuration is employed such that the information processing method S1 according to the present example embodiment includes: (a) analyzing a dependency structure of a sentence contained in a document concerning a business activity; (b) extracting, from the sentence, at least one word indicative of a target of a business action; and (c) on the basis of a result of analysis in (a), extracting, as a word indicative of the business action, at least one word having a dependency relation with the at least one word extracted in (b), (a) to (c) each being carried out by at least one processor. Thus, the information processing method S1 according to the present example embodiment brings about an effect of making it possible to accurately extract a business action from a document such as a daily business report.

### (Configuration of Business Action Extraction System)

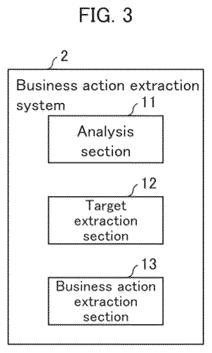

The following description will discuss a configuration of a business action extraction system 2 according to the present example embodiment with reference to FIG. 3. FIG. 3 is a block diagram illustrating the configuration of the business action extraction system 2. The business action extraction system 2 includes an analysis section 11 (analysis means), a target extraction section 12 (target extraction means), and a business action extraction section 13 (business action extraction means). The analysis section 11 analyzes a dependency structure of a sentence contained in a document concerning a business activity. The target extraction section 12 extracts, from the sentence, at least one word indicative of a target of a business action. On the basis of a result of analysis by the analysis section 11, the business action extraction section 13 extracts, as a word indicative of the business action, at least one word having a dependency relation with the word extracted by the target extraction section 12.

As described above, a configuration is employed such that the business action extraction system 2 according to the present example embodiment includes: the analysis section 11 that analyzes a dependency structure of a sentence contained in a document concerning a business activity; the target extraction section 12 that extracts, from the sentence, at least one word indicative of a target of a business action; and the business action extraction section 13 that, on the basis of a result of analysis by the analysis section 11, extracts, as a word indicative of the business action, at least one word having a dependency relation with the at least one word extracted by the target extraction section 12. Thus, the business action extraction system 2 according to the present example embodiment brings about an effect of making it possible to accurately extract a business action from a document such as a daily business report.

### Second Example Embodiment

### (Configuration of Information Processing Apparatus)

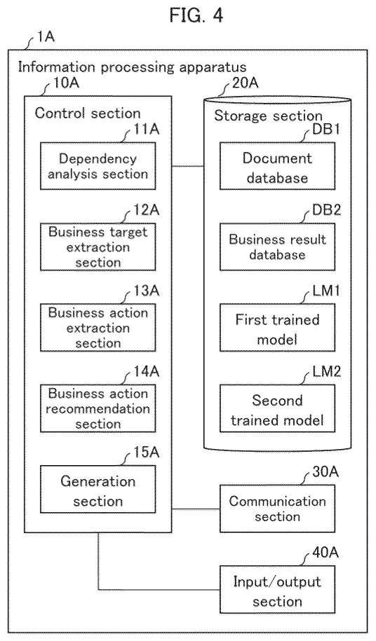

The following description will discuss a second example embodiment of the present invention in detail with reference to the drawings. FIG. 4 is a block diagram illustrating a configuration of an information processing apparatus 1A according to the second example embodiment. The information processing apparatus 1A is an apparatus that provides information for supporting a future business activity on the basis of a document such as a daily business report. The information processing apparatus 1A includes a control section 10A, a storage section 20A, a communication section 30A, and an input/output section 40A.

The communication section 30A communicates, via a communication line, with an apparatus external to the information processing apparatus 1A. A specific configuration of the communication line is not limited to the present example embodiment. Examples of the communication line include a wireless local area network (LAN), a wired LAN, a wide area network (WAN), a public network, a mobile data communication network, and a combination thereof. The communication section 30A transmits, to another apparatus, data supplied from the control section 10A, and supplies, to the control section 10A, data received from another apparatus.

To the input/output section 40A, an input/output apparatus(es) such as a keyboard, a mouse, a display, a printer, and/or a touch panel is/are connected. The input/output section 40A receives, from an input apparatus(es) connected thereto, an input of various pieces of information to the information processing apparatus 1A. The input/output section 40A outputs, to an output apparatus (es) connected thereto, various pieces of information under control by the control section 10A. Examples of the input/output section 40A include an interface such as a universal serial bus (USB).

The control section 10A collectively controls sections of the information processing apparatus 1A. The control section 10A includes a dependency analysis section 11A (analysis means), a business target extraction section 12A (target extraction means), a business action extraction section 13A (business action extraction means), a business action recommendation section 14A (output means), and a generation section 15A (generation means).

### (Dependency Analysis Section)

The dependency analysis section 11A analyzes a dependency structure of a sentence contained in a document concerning a business activity. The document concerning the business activity is a document describing, for example, details of the business activity in a natural language, and is, for example, a daily business report prepared by, for example, a sales representative. The natural language is, for example, Japanese, Chinese, or English. In the following description, for convenience of description, data indicative of a document is also simply referred to as “document”. Examples of the document concerning the business activity include text data indicative of the details of the business activity, a file created by predetermined document creation software, a file in Portable Document Format (PDF) format, and a file in hypertext markup language (HTML) format. The document concerning the business activity may be, for example, data generated by a user operating, for example, an input apparatus, or may be, for example, data generated by an apparatus such as the information processing apparatus 1A carrying out an audio analysis process with respect to an audio file showing the details of the business activity.

For example, the dependency analysis section 11A analyzes a dependency structure of a sentence by carrying out morphological analysis and syntactic analysis. Morphological analysis is a process for dividing a sentence into morphemes and determining, for example, the part of speech of each of the morphemes. Syntactic analysis is a process for clarifying a relationship between morphemes by, for example, diagramming the relationship. However, a method in which the analysis section 11 analyzes a structure of a sentence is not limited to the above-described example. The analysis section 11 may analyze the structure of the sentence by another method.

The dependency analysis section 11A may acquire a document that is input via the input/output section 40A. Alternatively, the dependency analysis section 11A may acquire the document from a storage location (which may be in a storage apparatus of the information processing apparatus 1A or in a storage apparatus outside the information processing apparatus 1A) specified by a user of the information processing apparatus 1A. The dependency analysis section 11A may receive the document from another apparatus via the communication section 30A.

The business target extraction section 12A extracts, from the sentence, a word or phrase indicative of a target of a business action. Note here that the phrase is a word string that represents a collective meaning. The word indicative of the target of the business action is, for example, a part corresponding to “xx” or “yy” in “e-mail Mr./Ms. xx” or “meeting with company yy”, and is, for example, a client name (company name, name of a person in charge, etc.). The phrase indicative of the target of the business action may be a phrase containing a word indicative of, for example, an event related to a client (e.g., “prepare material for regular meeting”). In the following description, a word or phrase (a plurality of words) is also simply referred to as “word”. In other words, the word indicative of the target of the business action herein includes the phrase indicative of the target of the business action. A process carried out by the business target extraction section 12A for extracting the word indicative of the target will be described later in detail.

On the basis of a result of analysis by the dependency analysis section 11A, the business action extraction section 13A extracts a word having a dependency relation with the word extracted by the business target extraction section 12A. For example, in a sentence “e-mail Mr./Ms. xx”, the business action extraction section 13A extracts, as a word indicative of the business action, a verb “e-mail” having a dependency relation with “Mr./Ms. xx” serving as the word indicative of the target. For example, in a sentence “reported progress of project A to Mr./Ms. xx”, the business action extraction section 13A extracts, as the word indicative of the business action, a word “reported” having a dependency relation with “Mr./Ms. xx” serving as the word indicative of the target.

The business action extraction section 13A outputs data indicative of the extracted word indicative of the business action. The business action extraction section 13A may output the data to an output apparatus connected to the input/output section 40A. Alternatively, the business action extraction section 13A may transmit the data to another apparatus connected via the communication section 30A. Note here that the output apparatus is, for example, a display, a printer, a projector, or a loudspeaker. The business action extraction section 13A may output the data by writing the data to the storage location (which may be in the storage apparatus of the information processing apparatus 1A or in the storage apparatus outside the information processing apparatus 1A) specified by the user of the information processing apparatus 1A.

On the basis of an output obtained by inputting, to a second trained model LM2, the word extracted by the business target extraction section 12A and the word extracted by the business action extraction section 13A, the business action recommendation section 14A outputs information that supports the business activity. Note here that the second trained model LM2 is a trained model which uses, as an input, a word indicative of a business target and a word indicative of a business action and which outputs information that supports a business activity. The information that supports the business activity includes, for example, information indicative of a recommended business action. A method of machine learning of the second trained model LM2 is not limited. The method may be, for example, a neural network method, a decision tree-based method, or a linear regression method. Alternatively, two or more of these methods may be used.

The generation section 15A generates the second trained model LM2 by machine learning in which training data is used. For example, the training data includes (i) the word extracted by the business target extraction section 12A, (ii) the word extracted by the business action extraction section 13A, and (iii) a label indicative of a result of the business activity. Note here that the label indicative of the result of the business activity is, for example, a label indicating whether a project has succeeded.

### (Storage Section)

The storage section 20A stores various data used by the information processing apparatus 1A. The storage section 20A stores, in particular, a document database DB1, a business result database DB2, a first trained model LM1, and the second trained model LM2. The document database DB1 is a database in which documents concerning the business activity are accumulated. The documents concerning the business activity are stored in various file formats such as a text file, a PDF file, and an HTML file. At least some of data stored in the document database DB1 is used for machine learning of the first trained model LM1 or the second trained model LM2.

The business result database DB2 is a database in which data indicative of the result of the business activity is accumulated. At least some of the data stored in the business result database DB2 is used for machine learning of the second trained model LM2.

The first trained model LM1 is a model used by the business target extraction section 12A to extract a word indicative of a business target. The first trained model LM1 is a model generated by machine learning in which a sentence in which a ground truth tag is assigned to the word indicative of the target of the business action is used as training data. A method of machine learning of the first trained model LM1 is not limited. The method may be, for example, a neural network method, a decision tree-based method, or a linear regression method. Alternatively, two or more of these methods may be used. An input to the first trained model LM1 in an estimation phase includes, for example, a sentence, and an output from the first trained model LM1 includes the word indicative of the target.

The expression “the storage section 20A stores the first trained model LM1 and the second trained model LM2” means that the storage section 20A stores a parameter defining the first trained model LM1 and a parameter defining the second trained model LM2.

### (Specific Example of Business Target Extraction Process)

Example processes 1 to 3 are described here as specific examples of a process carried out by the business target extraction section 12A for extracting the business target.

### (Example Process 1 for Extracting Target)

In the example process 1, the business target extraction section 12A extracts the word indicative of the target by inputting the sentence to the first trained model LM1 generated in advance by machine learning. The first trained model LM1 is, as described earlier, a model generated by machine learning in which a sentence in which a ground truth tag is assigned to the word indicative of the target of the business action is used as training data. A sentence contained in the training data is, for example, a sentence “reported progress of project C to Mr./Ms. zz” in which a ground truth tag is assigned to “Mr./Ms. zz”. Alternatively, the sentence contained in the training data is, for example, a sentence “hold kickoff meeting for project D” in which a ground truth tag is assigned to “kickoff meeting”.

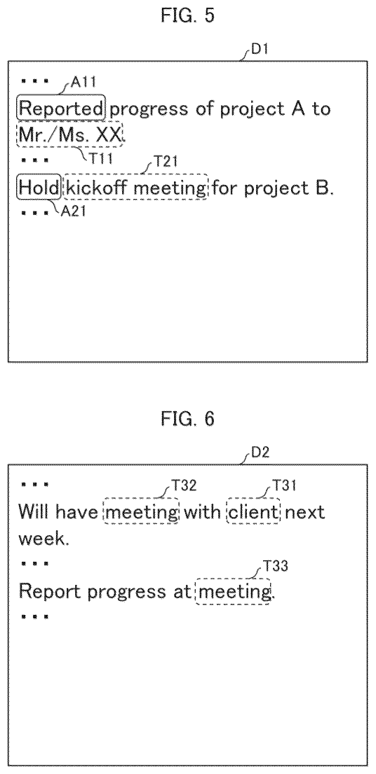

FIG. 5 is a diagram illustrating an example of a word indicative of a target and extracted by the business target extraction section 12A. In the example of FIG. 5, by inputting, to the first trained model LM1, a sentence “reported progress of project A to Mr./Ms. xx” contained in a document D1, the business target extraction section 12A extracts, from the sentence, “Mr./Ms. xx” as a word T11 indicative of the target of the business action. Furthermore, by inputting, to the first trained model LM1, a sentence “hold kickoff meeting for project B”, the business target extraction section 12A extracts, from the sentence, a word T21 “kickoff meeting”.

### (Example Process 2 for Extracting Target)

In the example process 2, the business target extraction section 12A extracts, as the word indicative of the target, not only the word extracted with use of the first trained model LM1 but also a word having a dependency relation with the word extracted by the business action extraction section 13A and indicative of the business action.

For example, in the sentence “reported progress of project A to Mr./Ms. xx”, in a case where the business target extraction section 12A uses the first trained model LM1 to extract “Mr./Ms. xx” and the business action extraction section 13A extracts “reported” as the word indicative of the business action, the business target extraction section 12A extracts, as the word indicative of the target, not only “Mr./Ms. xx” but also “progress” having a dependency relation with “reported”. That is, in this case, the business target extraction section 12A extracts, as the business target, a phrase “progress to Mr./Ms. xx”.

### (Example Process 3 for Extracting Target)

In the example process 3, the business target extraction section 12A extracts not only a first word but also a second word as the word indicative of the target, the first word being extracted from the sentence, the second word being identical or similar to a word extracted from the sentence and being extracted from a plurality of documents having a time-series relation and on the basis of the time-series relation.

More specifically, the business target extraction section 12A extracts, for example, the second word that appears, in the document from which the first word has been extracted, so as to follow the first word. For example, in a case where in a daily business report, a first phrase “meeting with Mr./Ms. xx” appears, and a second phrase “prepare material for meeting” appears so as to follow the first phrase, it is understood that the latter “meeting” is also the target of the business activity. Thus, the business target extraction section 12A that extracts, from a document, the phrase “meeting with Mr./Ms. xx” as the word indicative of the target also extracts, as the word indicative of the target of the business activity, the word “meeting” that appears downstream of the document.

FIG. 6 is a diagram illustrating an example of the word indicative of the target and extracted by the business target extraction section 12A. In the example of FIG. 6, the business target extraction section 12A that extracts, from a document D2, a word T31 “client” and a word T32 “meeting” as the word indicative of the target also extracts, as the word indicative of the target, a word T33 “meeting” which appears so as to follow the words T31 and T32.

The business target extraction section 12A may extract the word indicative of the target not only from a single document but also from a plurality of documents. For example, the business target extraction section 12A extracts the second word from a document concerning a business activity subsequent to a business activity corresponding to a document from which the first word has been extracted. For example, the business target extraction section 12A may extract the second word from a document that is prepared, after the document from which the first word has been extracted, for a project identical to the project of the document from which the first word has been extracted.

Note, however, that a method by which the business target extraction section 12A extracts the word indicative of the target is not limited to the methods shown in the above-described example processes 1 to 3. For example, the business target extraction section 12A may carry out natural language processing such as named entity extraction so as to extract a proper noun.

### (Specific Examples 1 to 4 of Business Action Extraction Process)

Next, example processes 1 to 4 will be described as specific examples of a process carried out by the business action extraction section 13A for extracting the business action.

### (Example Process 1 for Extracting Business Action)

In the example process 1, the business action extraction section 13A extracts, as the word indicative of the business action, a word having a dependency relation with the word extracted by the business target extraction section 12A and indicative of the target of the business action. In the example of FIG. 5, in the sentence “reported progress of project A to Mr./Ms. xx”, the business action extraction section 13A extracts, as the word indicative of the business action, a word All “reported” having a dependency relation with “Mr./Ms. xx” serving as the word indicative of the target. Furthermore, in the sentence “hold kickoff meeting for project B”, the business action extraction section 13A extracts, as the word indicative of the business action, a word A21 “hold” having a dependency relation with “kickoff meeting” serving as the word indicative of the target.

### (Example Process 2 for Extracting Business Action)

In the example process 2, the business action extraction section 13A extracts, as the word indicative of the business action, not only a first word having a dependency relation with the word extracted by the business target extraction section 12A but also a second word having a dependency relation with the first word. In this example, for example, in the sentence “reported progress of project A to Mr./Ms. xx”, the business action extraction section 13A not only extracts, as the word indicative of the business action, the word “reported” having a dependency relation with “Mr./Ms. xx” serving as the word indicative of the target, but also extracts, as the word indicative of the business action, “progress” having a dependency relation with “reported”. In other words, the business action extraction section 13A extracts a phrase “reported progress” as the word indicative of the business action.

### (Example Process 3 for Extracting Business Action)

In the example process 3, each word constituting the document is classified in a hierarchical structure, and the business action extraction section 13A selects granularity of a hierarchy and extracts a word corresponding to the selected granularity of the hierarchy. As an example of a classification method in a hierarchical structure, for example, each word is assigned a large classification, a medium classification, and a small classification. For example, in the case of a term “mandarin orange”, the large classification is “food”, the medium classification is “fruit”, and the small classification is “citrus”. The granularity of a hierarchy is the depth of a hierarchy of a term classified in a hierarchical structure. In the above-described example, the small classification is the deepest hierarchy (finest classification). In this case, for example, the business action extraction section 13A extracts the word indicative of the business action from a hierarchy to which the word extracted by the business target extraction section 12A and indicative of the target belongs.

### (Flow of Recommendation Information Output Process)

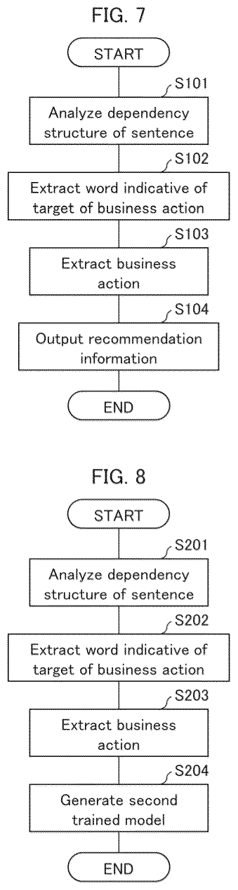

FIG. 7 is a flowchart showing an example flow of a recommendation information output process carried out by the information processing apparatus 1A. In step S101, the dependency analysis section 11A acquires a document concerning a business activity and analyzes a dependency structure of a sentence contained in the acquired document. In step S102, the business target extraction section 12A extracts, from the sentence, a word indicative of a target of a business action.

In step S103, on the basis of a result of analysis by the dependency analysis section 11A, the business action extraction section 13A extracts, as a word indicative of the business action, a word having a dependency relation with the word extracted by the business target extraction section 12A. For example, in a case where “Mr./Ms. xx” is extracted as the word indicative of the target of the business action in the sentence “reported progress of project A to Mr./Ms. xx”, the business action extraction section 13A extracts, as the word indicative of the business action, the word “reported” having a dependency relation with “Mr./Ms. xx”.

In step S104, on the basis of an output obtained by inputting, to the second trained model LM2, (i) the word extracted by the business target extraction section 12A and (ii) the word extracted by the business action extraction section 13A, the business action recommendation section 14A generates and outputs recommendation information for supporting the business activity.

### (Flow of Training Phase Execution Process)

FIG. 8 is a flowchart illustrating a flow of a training phase execution process carried out by the information processing apparatus 1A with respect to the second trained model LM2. In step S201, the dependency analysis section 11A analyzes a dependency structure of a sentence contained in a document concerning a business activity, the document being stored in the document database DB1. In step S202, the business target extraction section 12A extracts, from the sentence, a word indicative of a target of a business action. In step S203, on the basis of a result of analysis by the dependency analysis section 11A, the business action extraction section 13A extracts, as a word indicative of the business action, a word having a dependency relation with the word extracted by the business target extraction section 12A.

In step S204, the generation section 15A generates the second trained model LM2 by machine learning in which training data including (i) the word extracted by the business target extraction section 12A, (ii) the word extracted by the business action extraction section 13A, and (iii) a label indicative of a result of the business activity is used. For example, the label indicative of the result of the business activity is generated on the basis of data stored in the business result database DB2.

### (Effect of Information Processing Apparatus)

As described above, a configuration is employed such that in the information processing apparatus 1A according to the present example embodiment, the business target extraction section 12A extracts the word indicative of the target by inputting the sentence to the first trained model LM1 generated by machine learning in which a sentence in which a ground truth tag is assigned to a word indicative of a target of a business action is used as training data. Thus, the information processing apparatus 1A according to the present example embodiment makes it possible to accurately extract a word indicative of a target by using the first trained model LM1 generated with use of a sentence in which a ground truth tag is assigned to the word indicative of the target. This brings about an effect of making it possible to more accurately extract a business action.

A configuration is employed such that in the information processing apparatus 1A according to the present example embodiment, the business target extraction section 12A extracts, as the word indicative of the target, not only the word extracted with use of the trained model LM but also a word having a dependency relation with the word extracted by the business action extraction section 13A. The business target extraction section 12A extracts, for example, not only the word “Mr./Ms. xx” but also the word “progress” as the word indicative of the target of the business action. The present example embodiment thus makes it possible to extract more diverse information as a word indicative of a target. This brings about an effect of making it possible to more accurately extract a business action.

A configuration is employed such that in the information processing apparatus 1A according to the present example embodiment, the business target extraction section 12A extracts not only a first word but also a second word as the word indicative of the target, the first word being extracted from the sentence, the second word being identical or similar to a word extracted from the sentence and being extracted from a plurality of documents having a time-series relation and on the basis of the time-series relation. Extracting not only the first word but also the second word related to the first word brings about an effect of making it possible to reduce failure to extract a word indicative of a business target.

A configuration is employed such that in the information processing apparatus 1A according to the present example embodiment, the business target extraction section 12A extracts the second word from a document concerning a business activity subsequent to a business activity corresponding to a document from which the first word has been extracted. Not only extracting the first word but also extracting the second word from a document created later than a document in which the first word appears brings about an effect of making it possible to reduce failure to extract a word indicative of a business target.

A configuration is employed such that in the information processing apparatus 1A according to the present example embodiment, the business target extraction section 12A extracts the second word that appears, in the document from which the first word has been extracted, so as to follow the first word. Extracting not only the first word but also the second word that appears in the document so as to follow the first word brings about an effect of making it possible to reduce failure to extract a word indicative of a business target.

A configuration is employed such that in the information processing apparatus 1A according to the present example embodiment, the business action extraction section 13A extracts, as the word indicative of the business action, not only a first word having a dependency relation with the word extracted by the business target extraction section 12A but also a second word having a dependency relation with the first word. The business action extraction section 13A extracts, for example, not only the word “reported” but also a phrase “reported progress”. The present example embodiment thus brings about an effect of making it possible to extract more specific information as a word indicative of a business action.

A configuration is employed such that the information processing apparatus 1A according to the present example embodiment includes the business action recommendation section 14A which, on the basis of an output obtained by inputting, to the second trained model LM2, the word extracted by the business target extraction section 12A and the word extracted by the business action extraction section 13A, outputs information that supports the business activity. Thus, the information processing apparatus 1A according to the present example embodiment makes it possible to, merely by preparing a document such as a daily business report, output information that supports a business activity.

A configuration is employed such that the information processing apparatus 1A according to the present example embodiment further includes the generation section 15A that generates, by machine learning in which training data including the word extracted by the business target extraction section 12A, the word extracted by the business action extraction section 13A, and a label indicative of a result of the business activity is used, the second trained model LM2 outputting information that supports the business activity. Using the second trained model LM2 generated by the generation section 15A brings about an effect of making it possible to output the information that supports the business activity.

### [Software Implementation Example]

Some or all of functions of the information processing apparatuses 1 and 1A, and the business action extraction system 2 (hereinafter referred to as “information processing apparatus 1, etc.”) can be realized by hardware such as an integrated circuit (IC chip) or the like or can be alternatively realized by software.

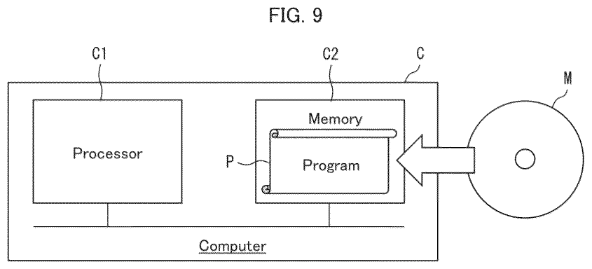

In the latter case, the information processing apparatus 1, etc. are each realized by, for example, a computer that executes instructions of a program that is software realizing the functions. FIG. 9 illustrates an example of such a computer (hereinafter referred to as “computer C”). The computer C includes at least one processor C1 and at least one memory C2. The memory C2 stores a program P for causing the computer C to operate as the information processing apparatus 1, etc. In the computer C, the processor C1 reads and executes the program P stored in the memory C2, so that the functions of the information processing apparatus 1, etc. are realized.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

An information processing apparatus including: an analysis means that analyzes a dependency structure of a sentence contained in a document concerning a business activity; a target extraction means that extracts, from the sentence, at least one word indicative of a target of a business action; and a business action extraction means that, on the basis of a result of analysis by the analysis means, extracts, as a word indicative of the business action, at least one word having a dependency relation with the at least one word extracted by the target extraction means.

### (Supplementary Note 2)

The information processing apparatus according to Supplementary note 1, wherein the target extraction means extracts the at least one word indicative of the target by inputting the sentence to a trained model generated by machine learning in which a sentence in which a ground truth tag is assigned to a word indicative of a target of a business action is used as training data.

### (Supplementary Note 3)

The information processing apparatus according to Supplementary note 2, wherein the target extraction means extracts, as the at least one word indicative of the target, not only the word extracted with use of the trained model but also a word having a dependency relation with the at least one word extracted in the business action extraction process.

### (Supplementary Note 4)

The information processing apparatus according to any one of Supplementary notes 1 to 3, wherein the target extraction means extracts not only a first word but also a second word as the at least one word indicative of the target, the first word being extracted from the sentence, the second word being identical or similar to the at least one word extracted from the sentence and being extracted from a plurality of documents having a time-series relation and on the basis of the time-series relation.

### (Supplementary Note 5)

The information processing apparatus according to Supplementary note 4, wherein the target extraction means extracts the second word from a document concerning a business activity subsequent to a business activity corresponding to a document from which the first word has been extracted.

### (Supplementary Note 6)

The information processing apparatus according to any one of Supplementary notes 1 to 5, wherein the business action extraction means extracts, as the word indicative of the business action, not only a first word having a dependency relation with the at least one word extracted by the target extraction means but also a second word having a dependency relation with the first word.

### (Supplementary Note 7)

The information processing apparatus according to any one of Supplementary notes 1 to 5, wherein on the basis of an output obtained by inputting, to a trained model, the at least one word extracted by the target extraction means and the at least one word extracted by the business action extraction means, the at least one processor further carries out an output process for outputting information that supports the business activity.

### (Supplementary Note 8)

A business action extraction method including: (a) analyzing a dependency structure of a sentence contained in a document concerning a business activity; (b) extracting, from the sentence, at least one word indicative of a target of a business action; and (c) on the basis of a result of analysis in (a), extracting, as a word indicative of the business action, at least one word having a dependency relation with the at least one word extracted in (b), (a) to (c) each being carried out by at least one processor.

### (Supplementary Note 9)

A program for causing a computer to carry out: (i) a process for analyzing a dependency structure of a sentence contained in a document concerning a business activity; (ii) a process for extracting, from the sentence, at least one word indicative of a target of a business action; and (iii) a process for, on the basis of a result of analysis through the process (i), extracting, as a word indicative of the business action, at least one word having a dependency relation with the at least one word extracted in the process (ii).

### (Supplementary Note 10)

A business action extraction system including: an analysis means that analyzes a dependency structure of a sentence contained in a document concerning a business activity; a target extraction means that extracts, from the sentence, at least one word indicative of a target of a business action; and a business action extraction means that, on the basis of a result of analysis by the analysis means, extracts, as at least one word indicative of the business action, a word having a dependency relation with the at least one word extracted by the target extraction means.

### (Supplementary Note 11)

The information processing apparatus according to Supplementary note 4 or 5, wherein the target extraction means extracts the second word that appears, in the document from which the first word has been extracted, so as to follow the first word.

### (Supplementary Note 12)

The information processing apparatus according to any one of Supplementary notes 1 to 7, further including a generation means that generates a trained model by machine learning in which training data including the at least one word extracted by the target extraction means, the word extracted by the business action extraction means, and a label indicative of a result of the business activity is used, the trained model outputting information that supports the business activity.

### (Supplementary Note 13)

An information processing apparatus including at least one processor, the at least one processor carrying out: an analysis process for analyzing a dependency structure of a sentence contained in a document concerning a business activity; a target extraction process for extracting, from the sentence, at least one word indicative of a target of a business action; and a business action extraction process for, on the basis of a result of analysis in the analysis process, extracting, as a word indicative of the business action, at least one word having a dependency relation with the at least one word extracted in the target extraction process.

Note that the information processing apparatus may further include a memory, which may store a program for causing the at least one processor to carry out the analysis process, the target extraction process, and the business action extraction process. The program may be stored in a non-transitory tangible computer-readable storage medium.

### REFERENCE SIGNS LIST

1, 1A Information processing apparatus
2 Business action extraction system
11, 11A Analysis section
12 Target extraction section
12A Business target extraction section
13, 13A Business action extraction section
14A Business action recommendation section
15A Generation section

1. An information processing apparatus comprising at least one processor, the at least one processor carrying out:
an analysis process for analyzing a dependency structure of a sentence contained in a document concerning a business activity;
a target extraction process for extracting, from the sentence, at least one word indicative of a target of a business action; and
a business action extraction process for, on the basis of a result of analysis in the analysis process, extracting, as a word indicative of the business action, at least one word having a dependency relation with the at least one word extracted in the target extraction process.

2. The information processing apparatus according to claim 1, wherein
in the target extraction process, the at least one processor extracts the at least one word indicative of the target by inputting the sentence to a trained model generated by machine learning in which a sentence in which a ground truth tag is assigned to a word indicative of a target of a business action is used as training data.

3. The information processing apparatus according to claim 2, wherein
in the target extraction process, the at least one processor extracts, as the at least one word indicative of the target, not only the word extracted with use of the trained model but also a word having a dependency relation with the at least one word extracted in the business action extraction process.

4. The information processing apparatus according to claim 1, wherein
in the target extraction process, the at least one processor extracts not only a first word but also a second word as the at least one word indicative of the target, the first word being extracted from the sentence, the second word being identical or similar to the at least one word extracted from the sentence and being extracted from a plurality of documents having a time-series relation and on the basis of the time-series relation.

5. The information processing apparatus according to claim 4, wherein
in the target extraction process, the at least one processor extracts the second word from a document concerning a business activity subsequent to a business activity corresponding to a document from which the first word has been extracted.

6. The information processing apparatus according to claim 1, wherein
in the business action extraction process, the at least one processor extracts, as the word indicative of the business action, not only a first word having a dependency relation with the at least one word extracted in the target extraction process but also a second word having a dependency relation with the first word.

7. The information processing apparatus according to claim 1, wherein on the basis of an output obtained by inputting, to a trained model, the at least one word extracted in the target extraction process and the at least one word extracted in the business action extraction process, the at least one processor further carries out an output process for outputting information that supports the business activity.

8. A business action extraction method comprising:
(a) analyzing a dependency structure of a sentence contained in a document concerning a business activity;
(b) extracting, from the sentence, at least one word indicative of a target of a business action; and
(c) on the basis of a result of analysis in (a), extracting, as a word indicative of the business action, at least one word having a dependency relation with the at least one word extracted in (b),
(a) to (c) each being carried out by at least one processor.

9. A non-transitory computer-readable storage medium storing therein a program for causing a computer to function as a business action extraction apparatus,
the program causing the computer to carry out:
(i) a process for analyzing a dependency structure of a sentence contained in a document concerning a business activity;
(ii) a process for extracting, from the sentence, at least one word indicative of a target of a business action; and
(iii) a process for, on the basis of a result of analysis through the process (i), extracting, as a word indicative of the business action, at least one word having a dependency relation with the at least one word extracted in the process (ii).
